(19) United States
(12) Patent Application Publication
(10) Pub. No.: US 2007/0086672 A1
(43) Pub. Date: Apr. 19, 2007

(54) System and method for partitioned-image filtering

(76) Inventors: Gengsheng L. Zeng, Holladay, UT (US); Richard J. Allred, Layton, UT (US)

Correspondence Address: THORPE NORTH & WESTERN, LLP., 8180 SOUTH 700 EAST, SUITE 200, SANDY, UT, 84070, US

(21) Appl. No.: 11/523,724

(22) Filed: Sep. 18, 2006

Related U.S. Application Data
(60) Provisional application No. 60/717,952, filed on Sep. 16, 2005.

(51) Int. Cl. G06K 9/40; G06K 9/00

(52) U.S. Cl. 382/261; 382/128

(57) ABSTRACT

A system and method are provided for processing visual imagery. The method may include the operations of collecting an image of medical radiology performed on a patient. An intensity gap analysis can be applied to the reconstructed image to determine partitioning values for the image. A further operation is dividing the image into sub-images, where each sub-image contains image values between adjacent thresholds of the partitioning values. Then the undefined image values in each sub-image may be set to a specified value interior to the partition values range for the sub-image. An additional operation is applying a linear filter to each sub-image separately. Finally, the sub-images are recombined only using the pixels with non-zero characteristic function values.

### CROSS-REFERENCE TO RELATED APPLICATIONS AND CLAIM OF PRIORITY

Priority of U.S. Provisional patent application Ser. No. 60/717,952 filed on Sep. 16, 2005 is claimed.

### GOVERNMENT FUNDING

The work for this project was performed under NIH government grant EB001489, EB003298, and CA100181.

### BACKGROUND

Removing noise from images involves deciding what is true image content and what is noise. When parts of the true image are removed during the noise reduction process, image artifacts or defects are created. When processing an image with a traditional linear filter the most common form of artifact is the Gibbs phenomenon or ringing around image jump discontinuities.

Linear filtering of images can suffers from a number of image distortions or defects. The well-known Gibb's Phenomenon, or oscillations in the areas of discontinuities, is the most common. These image artifacts are most severe when the image contains a high level of contrast.

Many different methods have been formulated to remove the Gibb's artifacts from a filtered signal. The most popular method is to apply a windowing function to the filter convolution kernel. This windowing method usually results in an over-smoothed or a blurred image.

Some researchers have proposed a pre-processing method to reduce the Gibb's effect in x-ray computed tomography (CT) by subtracting the high contrast information from the projection data. This approach is less effective because even though the image may have high contrast information, the projections of that image usually have a much lower contrast. This makes it difficult to identify and isolate the high contrast object.

### SUMMARY OF THE INVENTION

A system and method are provided for processing visual imagery. The method may include the operations of obtaining an image. An intensity gap analysis can be applied to the reconstructed image to determine partitioning values for the image. A further operation is dividing the image into sub-images, where each sub-image contains image values between adjacent thresholds of the partitioning values. Then the undefined image values in each sub-image may be set to a specified value interior to the partition values range for the sub-image. An additional operation is applying a linear filter to each sub-image separately.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a chart depicting an image that is subjected to an intensity gap analysis to determine the partitioning values in an embodiment of the invention;

FIG. 2 illustrates the filtering of a SPECT image that uses a bright biological marker;

FIG. 3 illustrates the filtering of bone SPECT image;

FIG. 4 is a flowchart illustrating a method for processing visual imagery in an embodiment of the invention;

FIG. 5a is a graph illustrating a noise-free signal composed of a large square pulse superimposed with two smaller pulses;

FIG. 5b is a graph illustrating a signal with added random noise;

FIG. 5c is a noisy Butterworth filtered signal with Gibbs ringing at the signal discontinuities;

FIG. 6a is a graph of a one-dimensional noisy signal with the partition threshold levels shown with horizontal dashed lines;

FIG. 6b is a graph of signal intensity distribution with partition threshold levels shown with dashed lines;

FIG. 7a illustrates a one-dimensional noisy signal with partition threshold levels shown with dashed lines;

FIG. 7b-f illustrates a one-dimensional noisy signal with a top partition P5, partition P4, partition P3, partition P2, and partition P1;

FIG. 8a-e illustrates processing of the unfiltered partitions;

FIG. 8f-j illustrates partitions filtered with the same Butterworth filter used to create the Butterworth filtered signal shown in FIG. 5c;

FIG. 9a-e illustrates an embodiment for recombining the filtered partitions with original data locations shown with heavy dots;

FIG. 9f illustrates a signal created from collecting the heavy dotted data points from each partition, this is what is called the partitioned-image filtered signal in an embodiment;

FIG. 10a-d illustrates regions of a partitioned-image filtered signal;

FIG. 11 illustrates four regions of comparison between the Noise Free Signal, the Butterworth Filtered Signal and the Partitioned-Image Filtered Signal;

FIG. 12a-b illustrates a frequency domain comparison between the partitioned-image filtered signal, the noise-free signal, and the Butterworth filtered signal; and

FIG. 13a-c illustrates a one-dimensional example of different schemes of defining the undefined pixels in each partition.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The present system and method includes the reduction of Gibb's phenomenon by partitioned-image filtering. Because the contrast of an image is the same as the contrast in the original object, the present method includes a post-filtering approach to reduce Gibb's phenomenon.

The partitioned-image filtering technique can reduce the Gibbs phenomenon in one-dimensional (1D), two-dimensional (2D) or three-dimensional (3D) images and signals. This method can exploit the properties of the Gibbs ringing based on assumptions about the structure of the image. The purpose of the method is to reduce the ringing in a filtered image while using the same desired filter. For example, a linear filter may continue to be used.

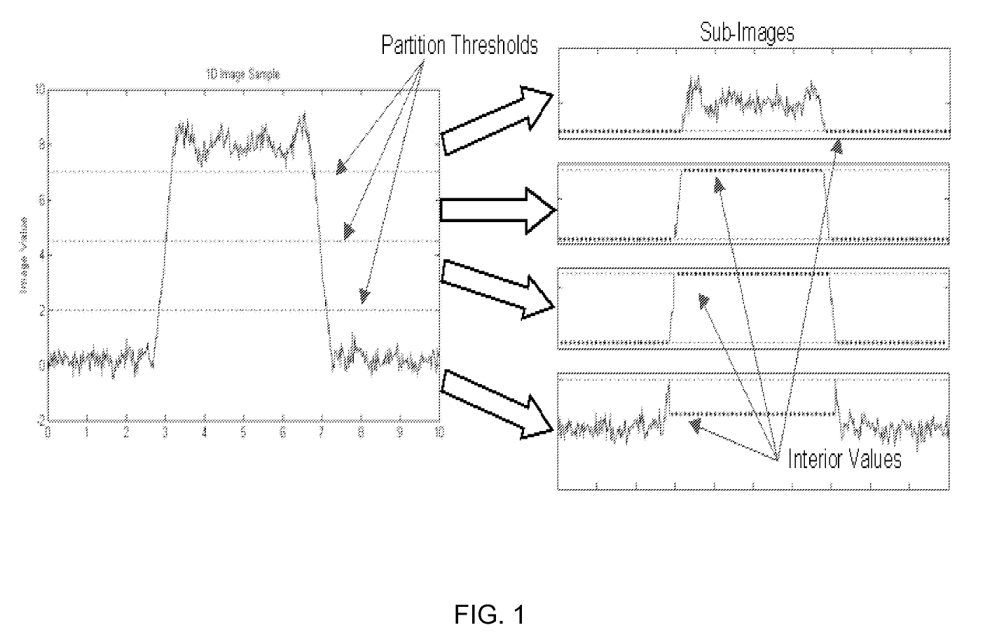

The method includes the following operations. First, the reconstructed image is subjected to an intensity gap analysis to determine the proper partitioning values as shown in FIG. 1. Threshold image values are determined to divide the image into sub-images. Each sub-image only contains those image values between the adjacent thresholds. Just two to five subdivisions can be used to obtain useful results. However, any number of subdivisions can be applied depending on the amount of processing power that is available.

Second, within each sub-image, the image values not defined by the original image are set to a specified value, which are interior to the partition range. Each sub-image is associated with a characteristic function that describes which partition each original pixel belongs to. This provides membership in the partition.

Third, a linear filter (for example, Butterworth or Metz filters) is then applied to each sub-image separately. Depending on the application, some sub-images may be left unfiltered. Finally, the sub-images are combined according to the characteristic function.

This partitioned-image filtering approach is not equivalent to a linear combination of the filtered sub-images. Each image pixel in the final image is taken from only one sub-image according to the characteristic function. Therefore this filtering approach is non-linear. Even though this is a non-linear filtering method, it is quite different from other common non-linear filters (e.g., the median filter), since partitioned image-filtering can be designed and applied by using conventional signal processing techniques in the frequency spectrum.

There are several reasons why the partitioned image filtering technique is able to reduce the Gibbs ringing. One is that the amplitude of the Gibbs ringing is directly proportional to the height of image discontinuity. By reducing the discontinuity, the Gibbs ringing is also reduced. Similarly, the partitioning process can be seen as the separation of image features, which are then able to be filtered independently of the rest of the image. This prevents the smearing of information from one feature to another and better represents the true image.

An example embodiment of the present system and method will now be described. The partitioned image filtering technique is shown as applied to two reconstructed images. Case one is a transaxial SPECT image slice of the human torso which has a bright external marker used to overlay the image with X-Ray CT or other images. The marker's magnitude is roughly 1600 normalized units while the signal of interest is about 100 to 200 normalized units.

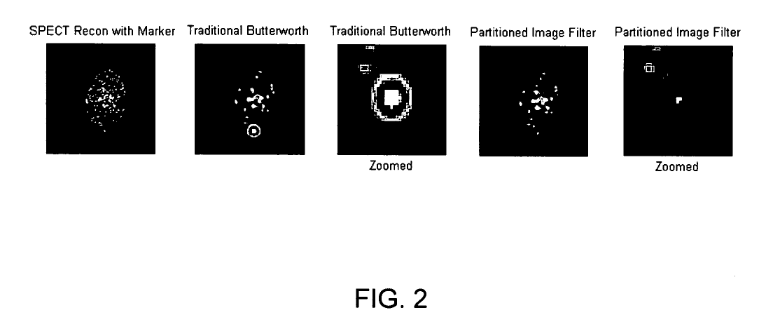

This discontinuity leads to significant ringing when a basic Butterworth low-pass filter is applied to the whole image as shown in FIG. 2. The display window is positioned on lowest 10% of image to show background information. The same Butterworth filter is used in the partitioned-image filtering technique, yielding significant improvements in image clarity.

It is observed from our marker example that our image-filtering process yields a much less severe Gibb's artifacts than traditional filtering. The marker size in our filtered image is the same as the original marker size. However, in the image filtered by the traditional approach, the marker is much larger. This artifact may cause significant errors in marker positioning. Also, the dark ringing artifact observed around the marker may affect important clinical information close to the marker.

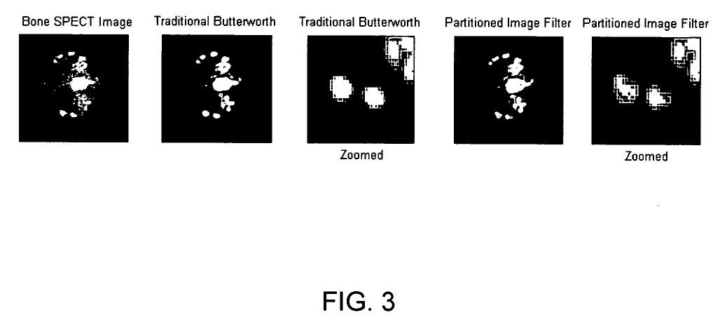

Case two is a basic bone SPECT. Here the maximum image-strength is less than 250 normalized units. A basic Butterworth low-pass filter is applied to the whole image and is compared to our filtering technique. Dark rings are also observed in the bone SPECT image filtered by the traditional approach which may damage important clinical information. FIG. 3 illustrates the filtering of bone SPECT image.

Overall, a substantial reduction in Gibbs artifacts can be achieved with a partitioned-image filtering approach. By isolating and removing the signal discontinuities, the Gibb's phenomenon oscillations are separated and discarded, and this produces superior images. The application of this filtering approach is not limited to SPECT images, it can be applied to other high contrast applications such as X-Ray CT. The present filtering approach can be used for any other applications outside of medicine, such as computer graphics generation, vehicle instrumentation, consumer digital imaging or other image applications where the image needs to reduce Gibbs artifacts.

The property of an image being exploited is that the image is composed of features which are able to be separated. An image feature is defined as a collection of neighboring pixels of similar intensity value that form a homogenous area distinct from other regions. The assumption is that if any given pixel has an intensity value close to the mean value of an image feature, then that pixel is a member of the feature.

Image discontinuities occur between the boundaries of image features. When the image features are separated, then independent processing of each feature is possible and a reduction of the image discontinuities is obtained. Images that exhibit this property are suitable to be processed with the partitioned-image filtering technique. Single Photon Emission Computed Tomography (SPECT) images and other medical images typically satisfy this assumption and to the degree that they do not satisfy this assumption there is an accompanying error.

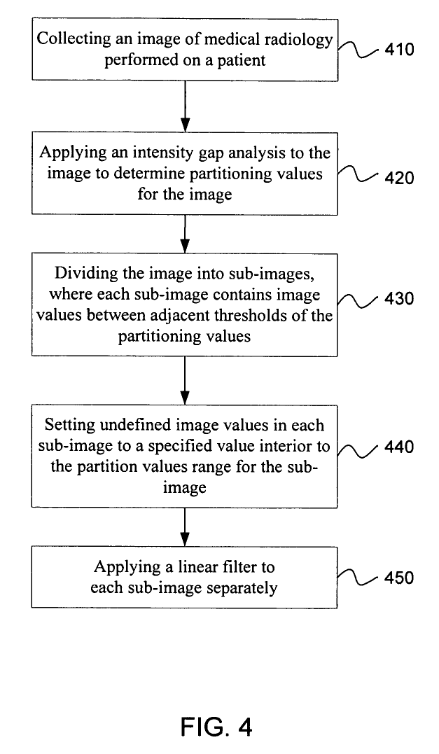

FIG. 4 provides a flow chart summary of the method of the invention. The method for processing visual imagery can include the operation of obtaining an image, as in block 410. A further operation is applying an intensity gap analysis to the image to determine partitioning values for the image, as in block 420.

The image can be divided into sub-images, and each sub-image can contain image values between adjacent thresholds of the partitioning values, as in block 430. A further operation is setting undefined image values in each sub-image to a specified value interior to the partition values range for the sub-image, as in block 440. Then a linear filter can be applied to each sub-image separately 450.

Partition location in the image is determined by consulting the image intensity distribution and inspecting the image itself. Partition threshold levels are selected which best separate image features and reduce image discontinuities. The partitions are created by distributing the image pixels to the various partitions depending on the pixel intensity value. Pixel values between consecutive threshold values are assigned to a certain partition and the remaining undefined pixel locations in each partition are given the upper or lower threshold value depending on whether the original image pixel in that location is distributed in a higher or lower partition. During the partitioning process a membership map is created that records which partition each image pixel belongs to. To recombine the partitions, the pixel values at the original pixel locations in each partition, as identified by the membership map, are collected and placed in the final image. This means the sub-images are recombined only using the pixels with non-zero characteristic function values.

The partitioned-image filtering technique will now be explained in more detail, with a mathematical description of the process as well as a one-dimensional example.

### Mathematical Description

The partitioned image filtering process is defined as follows: Let A be an N×N image, whose pixel values are denoted as aᵢⱼ, with the pixel locations defined by ij, where i, j=1, 2, . . . , N. Each pixel is partitioned into one of k partitions according to its intensity value, aᵢⱼ. The partitions are of dimension N×N and are denoted as P_{q}, where q=1, 2, . . . , k. There are k−1 partitioning threshold levels, represented as T₁, T₂, . . . , Tₖ₋ₗ, which are monotonically increasing and are contained in the range (T₀, Tₖ), where T₀ is the minimum image intensity value of A and Tₖ is the maximum image intensity value of A.

The pixel values of the qth partition, P_{q}, are denoted as P_{qij}, and are defined by equation (1.1). Equation (1.2) defines the membership map M, which is composed of components mᵢⱼ. M records which partition the pixel aᵢⱼ is assigned to and is later used in the image reconstruction. The remaining undefined pixel locations in each partition are given the upper or lower threshold value, T_{q} or T_{q-l}, depending on if the original image pixel is distributed in a higher or lower partition.

$$\begin{matrix}{p}_{qij} = \{ \begin{matrix} {T}_{q - 1} & if {a}_{ij} < {T}_{q - 1} \\ {a}_{ij} , & if {T}_{q - 1} \leq {a}_{ij} < {T}_{q} \\ {T}_{q} , & if {T}_{q} \leq {a}_{ij}\end{matrix} & ( 1.1 ) \\ {m}_{ij} = q , if {p}_{qij} = {a}_{ij} & ( 1.2 )\end{matrix}$$

Each partition, P_{q} is then processed by a previously specified filter, for example, a Fourier-domain low-pass Butterworth filter H as shown below in equation (1.3).
\tilde{P}_{q}=F⁻¹{F {P_{q}}H} (1.3)
where F is the Discrete Fourier Transform. The reconstructed image G which consists of pixels gᵢⱼ, is defined below in equation (1.4).
gᵢⱼ=\tilde{p}ₓᵢⱼ if x=mᵢⱼ (1.4)

Here, the membership map, mᵢⱼ, is used as a lookup table to determine which partition, x, to collect the intensity value from to store in gᵢⱼ. It is important to note that in the absence of any processing of the partitions, the reconstructed image G, is equivalent to the original image A.

For most of this study, as shown in equation (1.3), the Butterworth filter has been used, but any other filter or filtering scheme could be substituted for equation (1.3). To reiterate, the purpose of the partitioned-image filtering technique is (given an image which experiences Gibbs ringing when filtered) to reduce the amplitude of the Gibbs ringing while using the exact same filter. The general appeal of the low-pass Butterworth filter is that it has a smooth pass-band response, relatively narrow transition band, and has only two parameters, ω_{c} and n, which respectfully govern the cutoff frequency and filter order. In addition, the Butterworth filter is in current use in some nuclear medicine applications.

Another filtering issue is that under certain conditions selected partitions are not filtered at all. This stems from the observation that some of the partitions contain very few original pixels. Therefore, any filtering of these partitions would cause these few original pixels to be altered more than desired.

### One-Dimensional Example

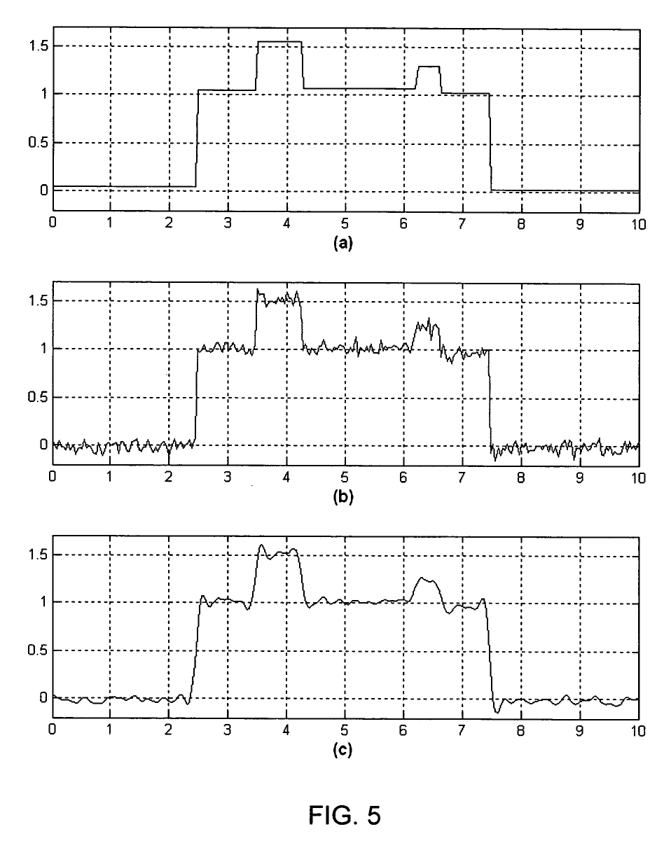

To further illustrate the partitioned-image filtering process, a one-dimensional example is given here. For consistency, the filtering technique may be referred to as the partitioned-image filtering technique rather than the partitioned-signal filtering technique. This one-dimensional example signal has been fabricated for illustration purposes and does not reflect any real data. The noise-free signal, shown in FIG. 5a, is a single square pulse to which two smaller square pulses has been added. In FIG. 5b, noise has been added to corrupt the noise-free signal and to create a noisy-signal. The traditional approach to remove noise is to apply a linear low-pass filter. In FIG. 5c, the noisy-signal has been filtered with the linear low-pass Butterworth filter. Note the Gibbs ringing which occurs at each of the sharp transition regions in the signal. It is this ringing which we are attempting to reduce.

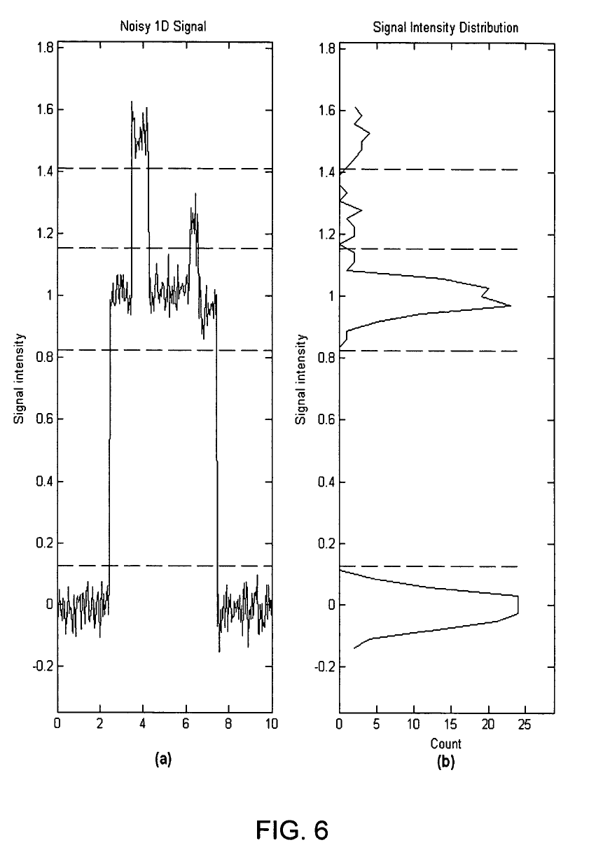

FIG. 6a and 6b show the partition threshold values in dashed lines with the noisy signal and the signal intensity distribution. As will be discussed in the next chapter, the threshold values are chosen that best separate image features and are identified by the minima in the intensity distribution.

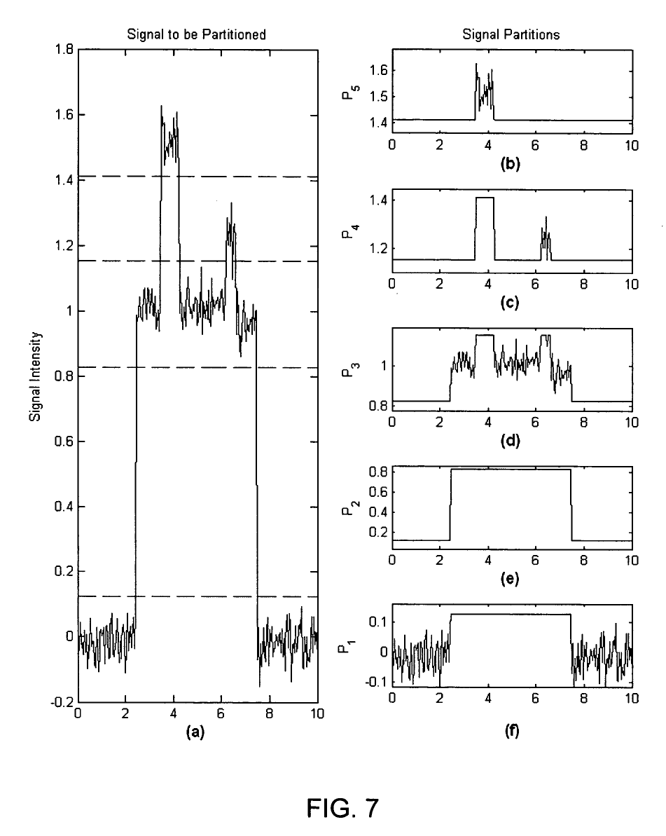

FIG. 7a shows the noisy signal again and FIGS. 7b-7f show the five partitions P₁-P₅ created from the signal. By cutting the signal along the intensity dimension each jump discontinuity is reduced, which will in turn reduce the Gibbs ringing when filtered.

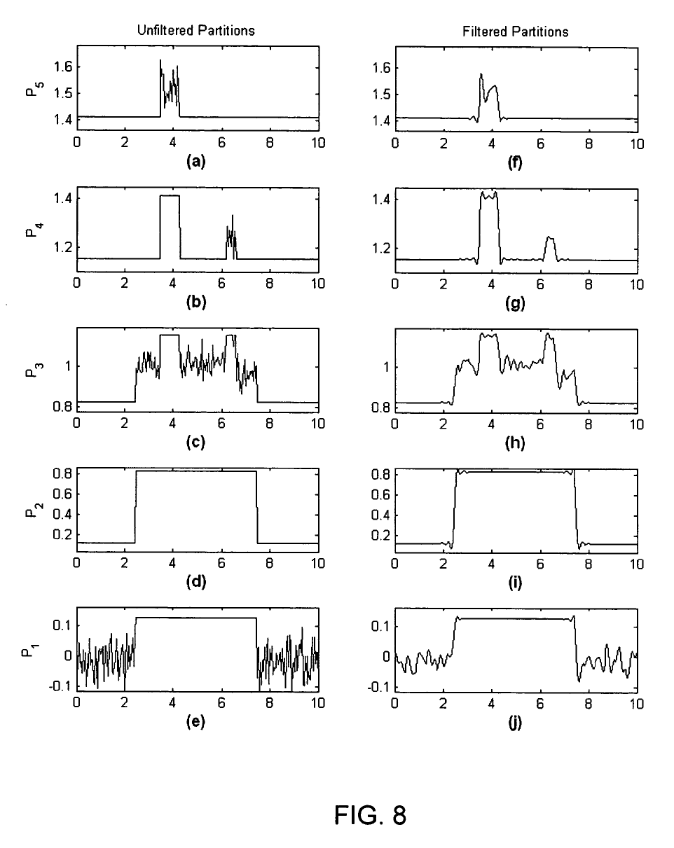

FIG. 8 shows the unfiltered and Butterworth filtered partitions. Note that the same Butterworth filter used in creating FIG. 5c is used to filter each of the partitions in FIGS. 8f-j.

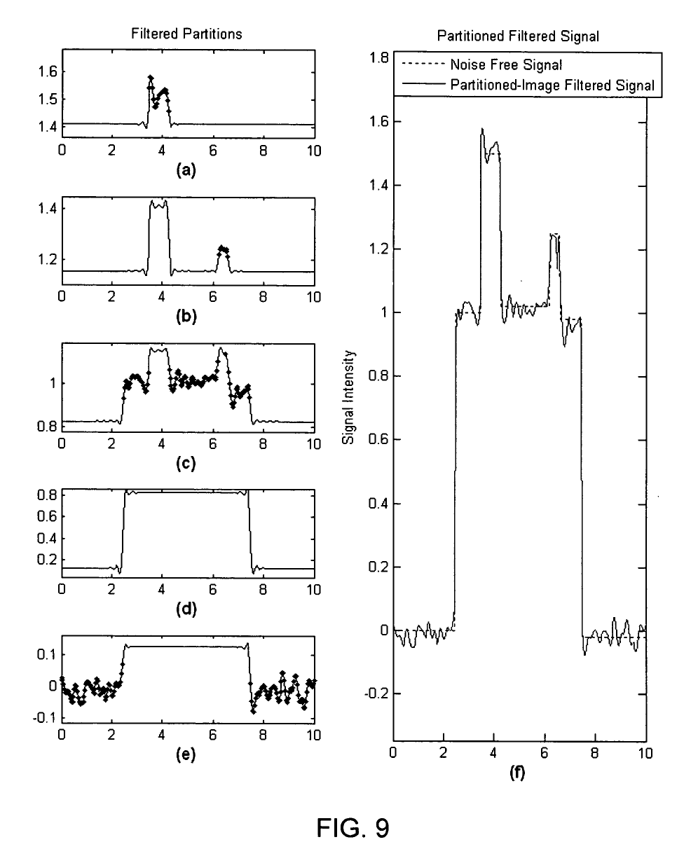

FIG. 9 shows the recombination of the partitions from FIG. 8. The original data points are shown with a heavy dot in FIGS. 9a-e. These data points are collected into the final signal shown in FIG. 9f. This is what we call the partitioned-image filtering process. Note that much of the Gibbs ringing that is present in FIGS. 9a-e is discarded through the nonlinear combination of the partitions. The recombination process does not recombine any data points not in the original signal that existed to create curves for and filter the separate partitions.

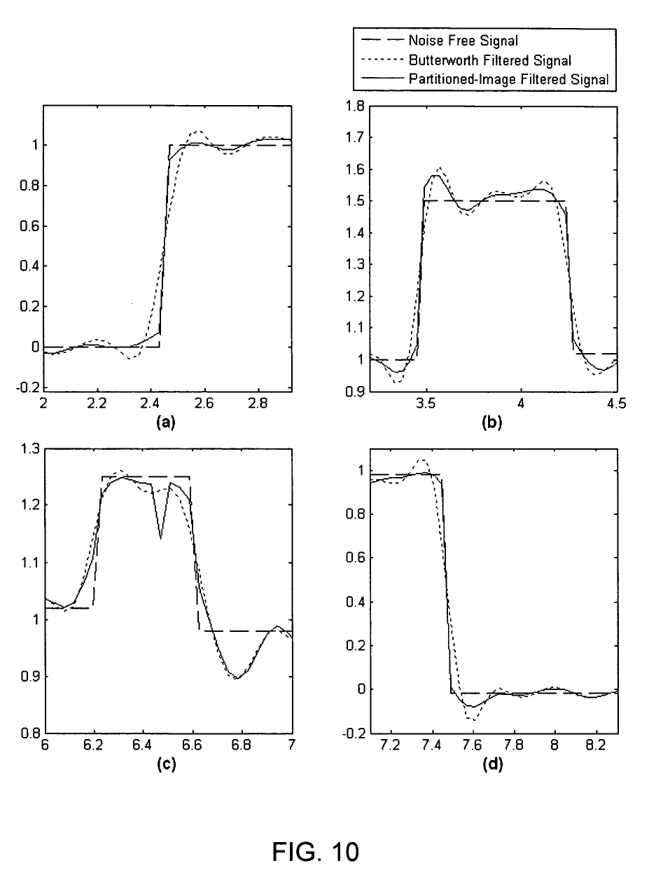

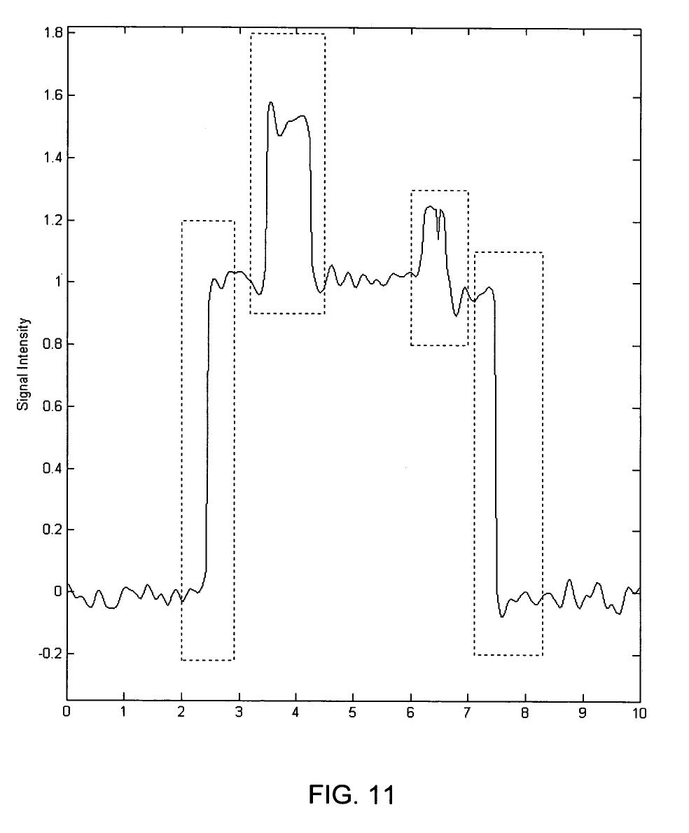

FIG. 11 show four regions of the partitioned-image filtered signal which will be directly compared to the Butterworth filtered signal and the noise-free signal in FIG. 10. The partitioned image filtered signal outperforms the Butterworth filtered signals in the reduction of the amplitude of the Gibbs ringing and in the increased slope at the signal discontinuities in FIGS. 10a, 10b and 10d. In FIG. 10c, the Butterworth filtered and partitioned-image filtered signals are very similar except the partitioned-image filtered signal has an interesting jump in it. This image ‘speckling’ can occur when a pixel is put in the wrong partition.

Outside these four regions the partitioned-image filtered signal and the Butterworth filtered signal are nearly identical. FIG. 10a shows the first of the regions which has a sharp signal discontinuity. Note how the partitioned-image filtered signal out performs the Butterworth filtered signal in both the magnitude of the overshoot and the signal slope at the point of discontinuity. FIG. 10b shows the first of the upper pulses and once again the partitioned-image filtered signal out performs the Butterworth filtered signal. FIG. 10c shows the second added pulse. The magnitude of this pulse is closer to the magnitude of the noise than the other pulses. Also in FIG. 10c is an example of one of the limitations of the partitioned-image filtering technique. The data point that is clearly out of place is what is called ‘speckling.’ This occurs when an image pixel is placed in a different partition than the other pixels in a homogeneous region. In FIG. 10d, like FIG. 10a, the partitioned-image filtered signal outperforms the Butterworth filtered signal in the neighborhood of the discontinuity.

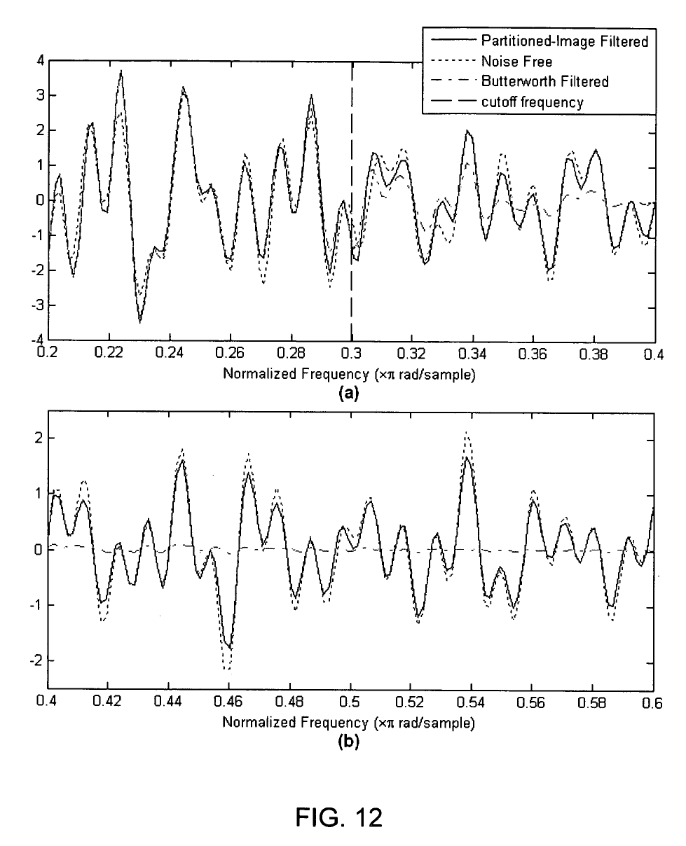

An interesting observation occurs when comparing the partitioned-image filtered signal, the Butterworth filtered signal and the noise-free signal in the frequency domain. It is noticed that the partitioned-image filtering method acts like a low-pass filter that selectively passes high frequency content. From examining the signals in FIGS. 12a and 12b it can be clearly seen that the high frequency content passed by the partitioned-image filtering method corresponds to the information needed to reconstruct the signal discontinuities. In FIG. 12a, below and near the cutoff frequency of the Butterworth

FIG. 12 illustrates a frequency domain comparison between the partitioned-image filtered signal, the noise-free signal, the Butterworth filtered signal. In 12a the frequency response of the partitioned-image filtered signal and the Butterworth filtered signal are very similar below the cutoff frequency of the filter. Above the cutoff frequency the frequency response of the partitioned-image filtered signal tracks the noise-free signal. It is evident in FIG. 12b that the frequency response of the partitioned-image filtered signal closely follows the response of the noise-free signal.

The partitioned-image filtering method closely tracks the Butterworth filtered signal, but above the cutoff frequency the partitioned-image filtered signal tracks the frequency response of the noise-free signal while the Butterworth filtered signal goes to zero. This is evident in FIG. 12b. This additional frequency data that the partitioned-image filtering method contains are the data needed to better reconstruct image discontinuities and therefore reduce Gibbs ringing.

### Selection of Partition Threshold Values

Threshold values are selected which best separate image features and reduce image discontinuities. Effective selection of the threshold values can reduce image speckling. The threshold values can be selected where the local minima of the image intensity distribution occur.

The image intensity distribution is computed as the intensity gap of the whole image. It reveals how the pixel values are distributed in intensity. Where there is a maxima in the distribution, it is surmised that this is the mean value of some image feature. Therefore, between two maximum points there will be a minimum and this is where the partition value is expected to lie if the two features are to be separated. This separation of image features allows for a reduction in image discontinuity and subsequent reduction in Gibbs ringing.

Image features with a relatively small population size pose a particular problem in identification since they are more susceptible to noise. In such cases, inspecting the image visually can help determine the partitioning thresholds.

The image can also be prefiltered to better reveal where the image features are. This prefiltering process allows improved separation of image features and will be discussed below.

When the threshold values are chosen where the image intensity distribution is nonzero, then speckling will occur. In applications where speckling is not acceptable, a more cautious approach of setting the threshold values only where the image intensity distribution is relatively close to zero is warranted.

### Prefiltering

To prepare for the image intensity distribution analysis, the image can be subjected to a prefilter which will reduce image noise and bring out image features. This process is important because without the optimum selection of the partition threshold values, the partitioned-image filtering method falls far short of its potential. The prefiltered image and the intensity distribution of the prefiltered image are then scrutinized to decide where to partition the image as discussed in the previous section. Examples of various prefilter schemes can be: the simple Butterworth filter, a nonlinear median filter, a Butterworth filter followed by the median filter, the Butterworth filter followed by the median filter iterated three times or other combinations of useful known filters.

One danger of using a prefilter is if the prefiltering is too strong, then the underlying image structure may become distorted. This can result in improper partition threshold values and introduce distortions into the final image.

Using the prefiltered image and the selected threshold values, a membership map is obtained, which records which pixels belong to which partition. This membership map is then applied to the original image to create the partitions. In practice, the lower partition may not be used because of the risk of creating speckling.

The prefilter is an example of using the combination of nonlinear and linear filtering together to extract information from a signal. Incorporating the prefiltering scheme into the partitioned-image filtering methods further illustrates the collective synergy of the creative confusion between the two types of filtering.

### Defining the Undefined

Another aspect of the partitioned-image filtering technique is defining the undefined pixels for partitions. As described, the pixel values between sequential threshold values are to be assigned to a certain partition, but what about the undefined pixels in each partition?

An upper-lower threshold value assignment can be given to each undefined pixel depending on whether the original pixel in that undefined pixel location was in a higher or lower partition. This upper-lower threshold value assignment can be effective in reducing image speckling and enabling smoother transitions in boundaries between image features in the reconstruction process.

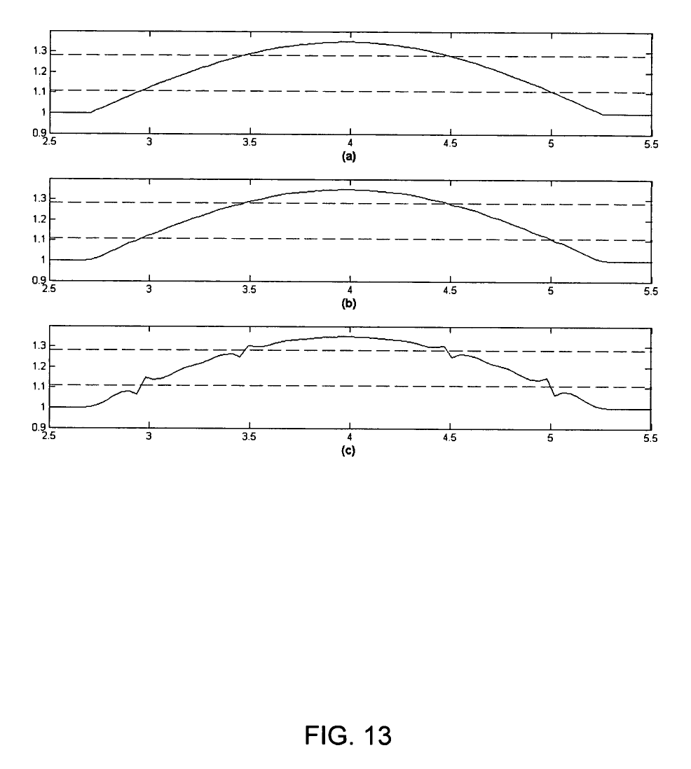

To illustrate the difference between the different partitioning schemes, a one-dimensional example is given. This fabricated signal is rounded on top and does not contain any discontinuities. Therefore, this example does not show a reduction of the Gibbs effect but shows how the definition of the undefined pixels of each partition affects the reconstructed image. FIG. 13a shows the example signal with two partition threshold levels shown with a dashed line, FIG. 13b shows a partitioned-image filtered signal using the upper-lower threshold assignment for the undefined points in each partition and FIG. 13c shows the partitioned-image filtered signal using the mean value of the defined points in a partition to define the undefined pixels. It is clear that the upper-lower threshold selection better matches actual signal behavior and introduces fewer image anomalies. If a partitioning threshold was inadvertently drawn though some smooth feature, then the smooth feature is unlikely to be disturbed by the partitioned-image filtering technique.

### Modification of Membership Map

The membership map governs the way the image partitions are recombined and another aspect of the method. Here we examine how modifying the membership map affects image speckling. Usually, it is possible to locate and identify a majority of the speckling which occurs in an image. This is done by examining the membership map to find any entries which are different than all of its neighbors. For instance, if the membership map, M, at the third row and fourth column, m_{3,4}, equals 3 while it's neighbors m_{2,3}, m_{2,4}, m_{2,5}, m_{3,3}, m3,5, m_{4,3}, m_{4,4}, m_{4,5}, all equal two, it would be concluded that speckling has occurred at the third row and fourth column of the image. By setting the membership map at m_{3,4}, to the same value of its neighbors, the speckling can be eliminated. This move is justified by the assumption that if a pixel belongs to a homogenous region then it will be similar in value to its neighbors. Therefore, by changing the membership map, the reconstructed image pixel will be closer to its ‘correct’ value than before.

The point-by-point search that is necessary to find the offending speckling locations is computationally a very expensive process which does not identify all speckling. The approach described above only finds isolated speckling points and does not identify the speckling if speckling occurs at two adjacent pixels. The point-by-point search can be expanded to include these other cases but the cost/benefit ratio is high. In addition, with each relaxation of the speckling search characteristics, the possibility of mistaking actual image features for speckling increases.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

1. A method for processing visual imagery, comprising:
collecting an image of medical radiology performed on a patient;
applying an intensity gap analysis to the image to determine partitioning values for the image;
dividing the image into sub-images, wherein each sub-image contains image values between adjacent thresholds of the partitioning values;
setting undefined image values in each sub-image to a specified value interior to the partition values range for the sub-image; and
applying a linear filter to each sub-image separately.

2. A method for processing visual imagery as in claim 1, further comprising the step of associating each sub-image with a characteristic function that describes the partition each original pixel belongs to.

3. A method for processing visual imagery as in claim 1, wherein the step of setting undefined image values in each sub-image further comprises the step of setting the undefined image values to a certain value within a sub-image range.

4. A method for processing visual imagery as in claim 1, further comprising the step of applying a linear filter.

5. A method for processing visual imagery as in claim 4, further comprising the step of applying a linear filter that is a Butterworth or Metz filter.

6. A method as in claim 1, wherein the step of dividing the image into sub-images further comprises the step of identifying a maxima of signal intensity for each of two features and finding a minimum signal intensity between the two maxima to define a partition value to separate the two features.

7. A method for processing visual imagery as in claim 1, further comprising the step of leaving selected sub-images unfiltered based on image application.

8. A method for processing visual imagery as in claim 1, further comprising the step of combining the images according to the characteristic function.

9. A method for processing a captured signal, comprising:
obtaining a signal for post processing;
applying an intensity gap analysis to the image to determine partitioning values for the image;
dividing the image into sub-images, where each sub-image contains image values between adjacent thresholds of the partitioning values;
setting undefined image values in each sub-image to a specified value interior to the partition values range for the sub-image; and
applying a linear filter to each sub-image separately.

10. A method as in claim 9, wherein the step of obtaining a signal for post processing further comprises the step of obtaining a two-dimensional image signal.

11. A method as in claim 9, wherein the step of obtaining a signal for post processing further comprises the step of obtaining a signal to form a three-dimensional image.

12. A method for processing visual imagery as in claim 9, further comprising the step of associating each sub-image with a characteristic function that describes the partition each original pixel belongs to.

13. A method for processing visual imagery as in claim 9, wherein the step of setting undefined image values in each sub-image further comprises the step of setting the undefined image values to a certain value within a sub-image range.

14. A method for processing visual imagery as in claim 9, further comprising the step of applying a linear filter.

15. A method for processing visual imagery as in claim 14, further comprising the step of applying a linear filter that is a Butterworth or Metz filter.

16. A method as in claim 9, wherein the step of dividing the image into sub-images further comprises the step of identifying a maxima of signal intensity for each of two features and finding a minimum signal intensity between the two maxima to define a partition value to separate the two features.

17. A method for processing visual imagery as in claim 9, further comprising the step of leaving selected sub-images unfiltered based on image application.

18. A method for processing visual imagery as in claim 9, further comprising the step of combining the images according to the characteristic function.

19. A method for processing visual imagery, comprising:
collecting an image of medical radiology performed on a patient;
applying an intensity gap analysis to the image to determine partitioning values for the image;
dividing the image into sub-images, wherein each sub-image contains image values between adjacent thresholds of the partitioning values;
setting undefined image values in each sub-image to a specified value interior to the partition values range for the sub-image;
applying a linear filter to each sub-image separately; and
recombining the sub-images using the pixels with non-zero characteristic function values.

20. A method as in claim 19, wherein the step of dividing the image into sub-images further comprises the step of identifying a maxima of signal intensity for each of two features and finding a minimum signal intensity between the two maxima to define a partition value to separate the two features.
